(19) United States
(12) Patent Application Publication
(10) Pub. No.: US 2012/0256827 A1
(43) Pub. Date: Oct. 11, 2012

(54) INPUT DEVICE AND ELECTRONIC DEVICE INCLUDING THE SAME

(76) Inventors: Keon Joon Ahn, Seongnam-si (KR); Jae Woo Han, Bucheon-si (KR)

(21) Appl. No.: 13/080,002

(22) Filed: Apr. 5, 2011

(51) Int. Cl. G06F 3/033

(52) U.S. Cl. 345/157

(57) ABSTRACT

The present disclosure relates to an input device used as an interface for an electronic device, and an electronic device including the same. The input device includes an interface unit mounted on a main body of an electronic device, and a bottom pad having a predetermined thickness and stacked on a bottom of the interface unit. The bottom pad is disposed in the interface unit to adjust the thickness of the input device in accordance with variation in the size of the electronic device. Therefore, the interface unit can be applied to electronic devices having various sizes by changing the bottom pad.

### BACKGROUND OF THE INVENTION

1. Field of the Invention

The present invention relates to an input device and an electronic device including the same, and more particularly, to an input device, which is used as an interface of various electronic devices such as mobile terminals or the like to operate the electronic device or to input data or signals and may be applied to various sizes of electronic devices, and electronic devices including the same.

2. Description of the Related Art

In general, electronic devices such as mobile terminals or personal digital assistants (PDAs) employ a key pad-based interface as an input unit, i.e. an input device.

More specifically, the electronic device, for example, a portable electronic device, includes buttons or keys for inputting numerals, characters or symbols, selecting functions or turning-on/off the electronic device, and the like. Further, a user inputs numerals, characters or symbols to the portable electronic device or operates the portable electronic device by pressing the buttons or keys.

Recently, in order to support a communication service or an Internet service through the electronic device, a wireless mobile communication service and a wireless Internet service such as wireless broadband (WIBRO) has been commercialized. Also, a portable electronic device such as a mobile phone, a PDA or the like adopts a window operating system such as Windows CE to support a graphic user interface (GUI).

Along with the development of communication technology, the portable electronic device provides various additional and supplementary services to a user, and the GUI-based Windows operating system is convenient for the portable electronic device to provide the additional services.

As a user interface for a general electronic device, there is an input device, especially a pointing device such as a mouse, a joystick, or etc. Recently, an optical pointing device, which senses an optical signal varied depending on motion of a subject (e.g., a finger) to move a pointer such as a cursor or to receive input of a command and/or information desired by a user, has been developed and applied to the input device for the electronic device.

Referring to FIGS. 1 and 2, as an example of the input device, an optical pointing unit 10 includes a light source (not shown), an optical sensor 12 for sensing an optical signal, a printed circuit board 13 having the optical sensor 12 mounted thereon, and a housing 14 for covering internal components, such as the light source, the optical sensor 12, etc.

The housing 14 is provided with a holder (not shown) for supporting optical members 15, 16, such as prisms 15a, 15b or a lens 16. The printed circuit board 13 is connected to a main circuit board via a connector 13a.

The optical pointing device 10 may be directly mounted to a main body 2 of the electronic device 1. Furthermore, in case that the optical pointing device and the electronic device 1 are incorporated as a single body, the optical pointing device preferably has a minimized thickness to make the electronic device 1 slim.

The housing 14 has an interface surface on an outer side thereof to bring a subject such as a finger or the like into contact with the interface surface in order to operate the electronic device, and the optical sensor 13 is provided on a printed circuit board (PCB) to process an input signal.

And, if the subject being in contact with the interface surface moves, the optical signal detected by the optical sensor 13 is also varied. Further, the optical signal sensed by the optical sensor 13 is processed by a controller having an image processor, and thus move of the cursor or contents of the input information can be displayed on the display unit of the electronic device according to the motion of the subject, or a menu of contents desired by a user can be selected or characters or numerals can be input to the electronic device.

The optical signal detection and image control by the optical sensor 13 are similar to those of a mouse of a computer. Therefore, details of the optical signal detection and image control will be omitted in the following description.

As described above, the input device such as the optical pointing unit is mounted on the main body of the electronic device to serve as an interface of the electronic device.

The size of the electronic device, in particular, the thickness of the electronic device, varies according to product model or kind. For example, if an installation height of the input unit on the electronic device is changed due to variation in the size of the electronic device, the input unit mounted on the electronic device forms a step on a surface of the electronic device, thereby detracting from the outer appearance of the electronic device.

Therefore, the input unit cannot be applied to various sizes of electronic devices and a manufacturer of the input device must prepare separate input devices corresponding to the thickness of the electronic device by changing the thickness of the housing and the thickness of internal components, e.g., the holder, optical members, etc., received in the housing in accordance with design requirements of the electronic device.

In this case, since it is necessary to provide separate molds, manufacturing lines and assembly lines corresponding to variation in size of components such as the housing, the holder, etc., manufacturing costs are significantly increased to provide input devices corresponding to the kinds or models of electronic devices, so that the price of the electronic device increases, thereby burdening consumers.

### SUMMARY OF THE INVENTION

One aspect of the present invention is to provide an input device, which can be used in common for various sizes of an electronic device, and an electronic device, in particular, a portable electronic device, including the same.

An exemplary embodiment of the invention provides an input device for an electronic device. The input device includes: an interface unit mounted on a main body of the electronic device; and a bottom pad having a predetermined thickness and stacked on a bottom of the interface unit.

The bottom pad comprises a pad layer comprising one of a soft material, a cushioning material and an elastic material. And the pad layer comprises one of a silicon pad, a urethane pad and a rubber pad.

In the present invention, the bottom pad is disposed in the interface unit to adjust a thickness of the input device in accordance with variation in size of the electronic device.

And the interface unit comprises an interface body for an interface, and a circuit board in the interface body. The interface unit may further comprise a pressing switch disposed between the circuit board and the bottom pad and compressed by the bottom pad as the interface unit is pressed down. The pressing switch protrudes downwards from a bottom of the circuit board, and the bottom pad comprises a base pad part contacting the circuit board, and a press pad part disposed on the base pad part and protruding downwards from the base pad part to compress the pressing switch.

The press pad part comprises a top surface contacting the pressing switch, the top surface of the press pad part comprising a recess for accommodating the pressing switch.

And the input device may further comprise a protrusion on a bottom of the press pad part. The base pad part is integrally formed with the press pad part. In addition, the bottom pad may comprise an alignment mark for aligning with the pressing switch. And the bottom pad may be attached to the bottom of the interface unit.

The interface unit comprises at least one of a pointing unit, a sensing unit, a fingerprint recognition unit, and a click unit. The pointing unit comprises a signal source generating a pointing signal, a sensor sensing the signal, a circuit board electrically connected to the sensor, and a housing defining an outer appearance of the pointing unit.

Another exemplary embodiment of the invention provides an input device of an electronic device, comprising: a pointing unit mounted on a main body of the electronic device, the pointing unit comprising a light source for emitting pointing light, an optical sensor for sensing light, a circuit board electrically connected to the optical sensor, and a housing defining an outer appearance of the pointing unit; and a bottom pad having a predetermined thickness and stacked on a bottom of the pointing unit, the bottom pad comprising a pad layer which comprises one of a soft material, a cushioning material and an elastic material.

The pointing unit further comprises a pressing switch disposed between the circuit board and the bottom pad and compressed by the bottom pad as the pointing unit is pressed down.

The pressing switch protrudes downwards from a bottom of the circuit board, the bottom pad comprises a base pad part contacting the circuit board, and a press pad part disposed on the base pad part and protruding downwards from the base pad part to compress the pressing switch, and the press pad part comprises a top surface contacting the pressing switch, the top surface of the press pad part comprising a recess for accommodating the pressing switch.

The pressing switch comprises a dome switch, and the bottom pad is attached to the bottom of the circuit board.

Another exemplary embodiment of the invention provides a portable electronic device, which includes a main body of the electronic device having a main circuit board; an interface unit mounted on the main body of the electronic device; and a bottom pad having a predetermined thickness and stacked on a bottom of the interface unit.

According to one exemplary embodiment of the invention, the interface unit, i.e. the input unit, can be applied to various sizes of electronic devices, thereby reducing manufacturing costs of the input device and providing adaptability.

### BRIEF DESCRIPTION OF THE DRAWINGS

The above and other aspects, features and advantages of the invention will become apparent from the following description of exemplary embodiments in conjunction with the accompanying drawings, in which:

FIG. 1 is a sectional view of an optical pointing device as an example of an input device;

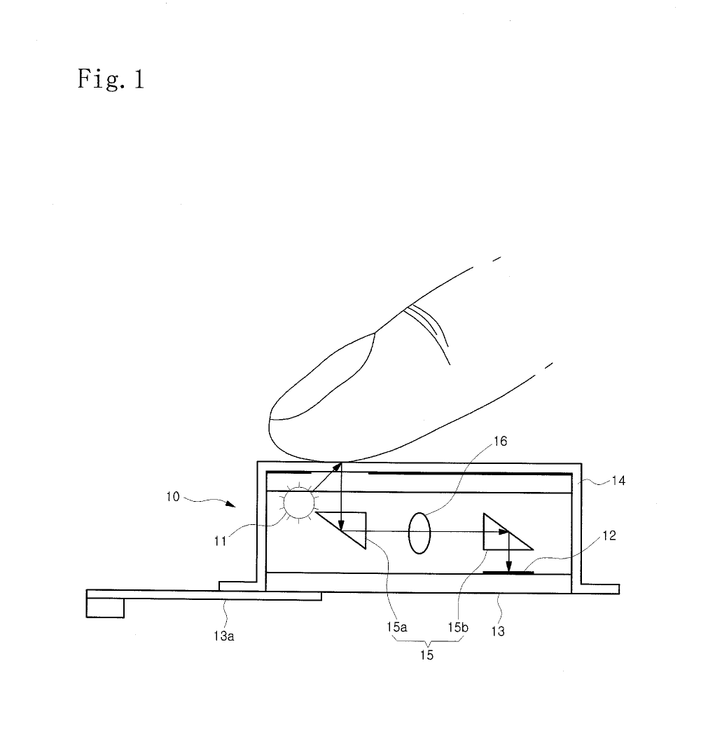

FIG. 2 is a perspective view of an electronic device including an input device according to one exemplary embodiment of the invention;

FIG. 3 is a schematic side-sectional view of an input device according to a first exemplary embodiment of the invention;

FIG. 4 is a side-sectional view of the input device shown in FIG. 3, in which an optical pointing unit is used as an example of an interface unit of the input device;

FIG. 5 is an exploded perspective view of the input device of FIG. 4;

FIG. 6 is a schematic side-sectional view of an input device according to a second exemplary embodiment of the invention;

FIG. 7 is a side-sectional view of the input device shown in FIG. 6, in which an optical pointing unit is used as an example of an interface unit of the input device

FIG. 8 is an exploded side-sectional view of the input device of FIG. 7;

FIG. 9 is an exploded perspective view of the input device of FIG. 8; and

FIG. 10 is a side-sectional view of an input device according to a third exemplary embodiment of the invention.

### DETAILED DESCRIPTION OF THE EMBODIMENT

Exemplary embodiments of the invention will now be described with reference to the accompanying drawings. Reference will now be made in detail to the preferred embodiments of the present invention, examples of which are illustrated in the accompanying drawings. Wherever possible, the same reference numbers will be used throughout the drawings to refer to the same or like parts.

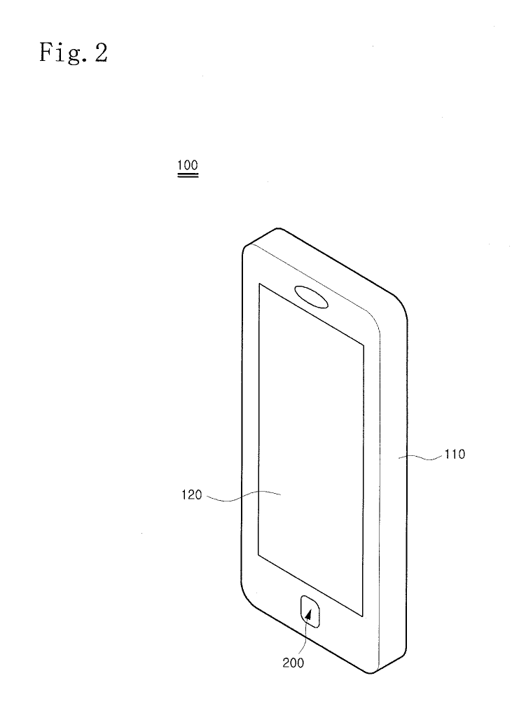

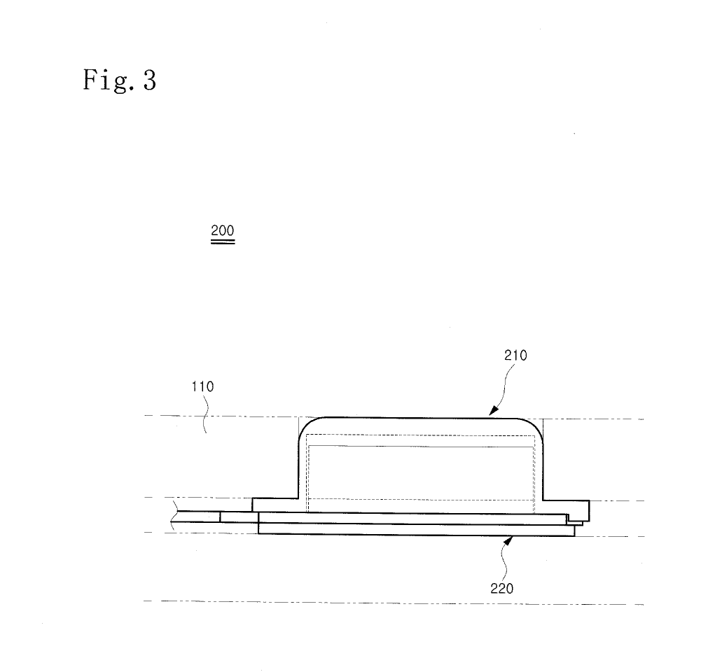

Firstly, an input device and an electronic device having the same according to a first embodiment of the present invention will be described with reference to FIGS. 2 to 5.

According to one exemplary embodiment, an input device 200 is mounted on a main body 110 of an electronic device and used when inputting data or signals, operating the electronic device, etc. That is, the input device 200 is used as an interface of the electronic device. Examples of the electronic device 100 include portable electronic devices such as mobile terminals, e.g., mobile phones such as smart-phones or the like, personal digital assistants (PDAs), navigation systems, remote controllers, and the like.

Referring to FIGS. 2 to 5, an input device 200 according to a first exemplary embodiment serves as an input unit for inputting data, signals or the like, and includes an interface unit 210 assembled to the main body 110 of the electronic device 200, and a bottom pad 220 stacked on the bottom of the interface unit 210 to increase the thickness of the input device 210. For example, the input device 200 may be an input device module mounted in the electronic device 200, in which the interface unit 210 is coupled to the bottom pad 220.

For installation of the input device 200, the bottom pad 220 has a predetermined thickness corresponding to the height of a mounting part in the main body 110 of the electronic device 100.

Specifically, the bottom pad 220 is disposed on the bottom of the interface unit 210 so as to adjust the thickness of the input device 200 in accordance with variation in the size, i.e., the thickness, of the electronic device 110. In the case where the height of the mounting part is changed due to change of the kind or model of the electronic device 100, the bottom pad having a different thickness is disposed on the bottom of the interface unit 210.

Therefore, the bottom pad 220 may be replaceable on the bottom of the interface unit 210. In other words, if the thickness of the input device 200 does not meet design requirements for the electronic device 100, the bottom pad 220 may be removed from the interface unit and a new bottom pad having a different thickness may be provided thereto.

The bottom pad 220 may include a pad layer made of any soft material, cushioning material or elastic material such that a user can smoothly manipulate the input device 200. For example, the pad layer may be one of a silicon pad, a urethane pad and a rubber pad.

Thus, the bottom pad 220 may give soft feeling when a user manipulates the input device 200. Further, the bottom pad 220 having the same thickness may compensate for difference in thickness of the input device 200 within a predetermined range even when the height of the mounting part is changed due to the thickness of the cushioning material.

Here, the bottom pad 220 may have a single layer or multiple layers. In this embodiment, the bottom pad is a single pad layer made of a silicon material, although the invention is not limited thereto.

In this embodiment, the bottom pad 220 is stacked on the bottom of the interface unit 210 to adjust the thickness of the input device 200 in accordance with variation in the size, particularly, the thickness, of the electronic device 100.

Further, the bottom pad 220 is secured to the bottom of the interface unit 210. For example, the bottom pad 220 may be attached to the interface unit 210 by an adhesive tape such as a double-sided adhesive tape, glue, etc., or may be mechanically coupled to the interface unit 210. The bottom pad 200 may have an alignment mark for aligning with the interface unit 210.

Obviously, the bottom pad 220 may be formed on the bottom of the interface unit 210 by applying silicone to a predetermined thickness to the bottom of the interface unit 210.

For example, the interface unit 210 may take various forms such as click units for selecting a function or a menu, various pointing units including an optical pointing device, sensing units, fingerprint recognition units, and the like. These may be applied to the interface units of other exemplary embodiments described below.

In one embodiment, the interface unit 210 includes an interface body for interfacing with the electronic device 100, and a circuit board 213 disposed in the interface body.

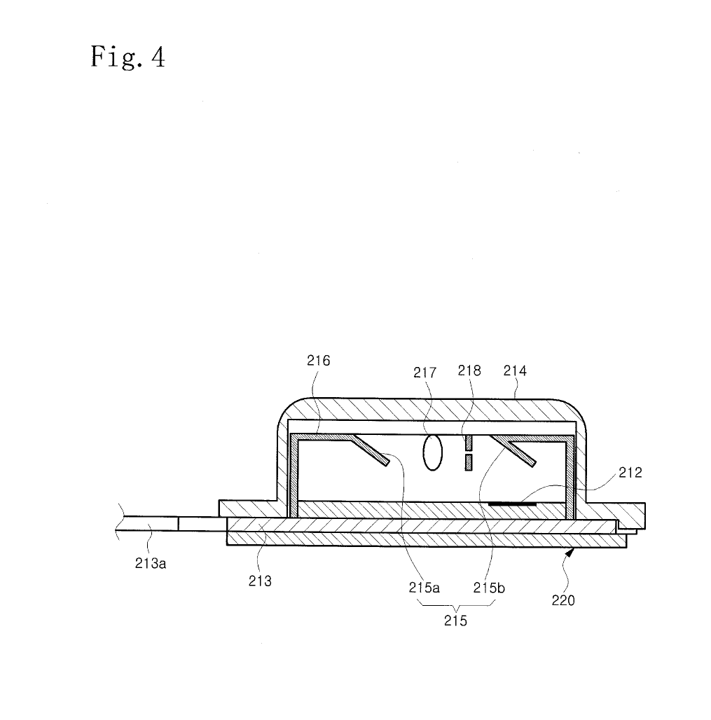

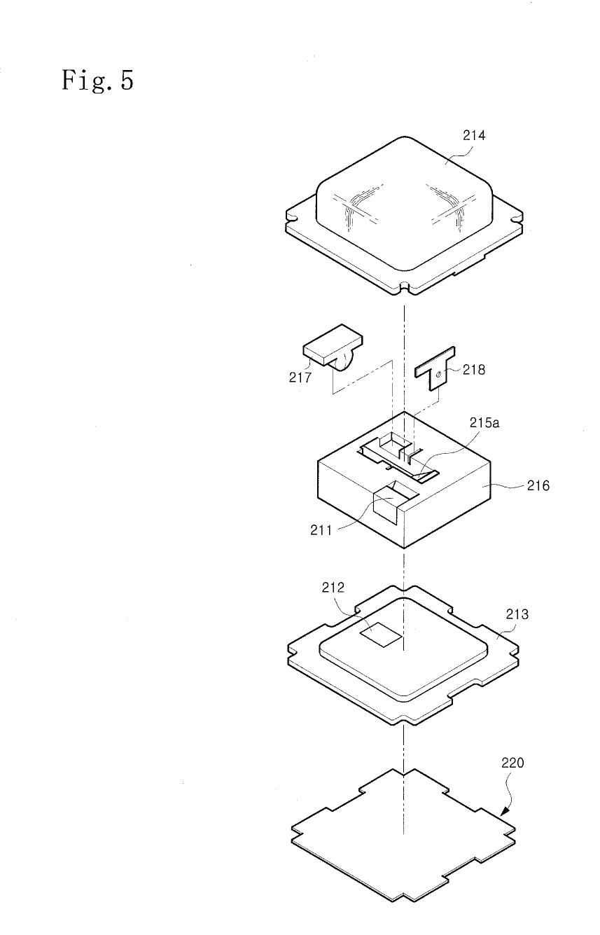

Referring to FIGS. 4 and 5, a pointing unit will be described in more detail as an example of the interface unit 210.

The pointing unit 210 includes a signal source 211 for generating a pointing signal, a sensor 212 for sensing the signal, a circuit board 213 electrically connected to the sensor 212, and a housing 214 defining an outer appearance of the pointing unit 210. In this embodiment, the interface body includes the signal source 211, the sensor 212, and the housing 214.

Herein, an optical pointing device having the pointing unit 210 is illustrated as an example of the input device 200. The optical pointing device will be illustrated as an input device of other exemplary embodiments described later.

One example of the signal source 211 includes a light source 211 for emitting light for sensing an object. In this case, an optical sensor, e.g., an image sensor, may be used as the sensor 212, and the bottom pad 220 may be disposed on the pointing unit 210.

Further, the circuit board 213, more specifically, a printed circuit board (PCB), is connected to a main circuit board (not shown) of the electronic device via a connector 213a such as a flexible printed circuit board (FPCB), and transmits an electric signal to the main circuit board. In this embodiment, the optical sensor 212 is mounted on the circuit board.

Further, an optical guide is disposed in the housing 214 to guide light emitted from the light source 211 and reflected by the object to the light sensor 212.

At least one of the optical guide, the light source and the optical sensor may be secured to the circuit board by a molding material. The optical guide may include various optical members such as a prism, a light guide plate, a mirror, an optical fiber, etc.

In this embodiment, the optical guide transmits light to the optical sensor 212 disposed in the housing 214 and includes a reflector 215 for changing a traveling direction of light to slim the interface unit 210. Further, an internal body 216 for preventing movement of the reflector 215 is assembled inside the housing 214.

In this embodiment, the reflector 215 is integrally formed with the internal body 216. As a result, the number of components may be reduced and an assembly procedure may be simplified.

It is desirable that the size of the optical pointing device be reduced in keeping with the current trend of miniaturizing electronic devices. Therefore, internal components of the pointing unit 210 are also manufactured to have very small sizes. According to the invention, however, there is no difficulty relating to assembly of very small optical members, such as a prism or a reflecting mirror to a conventional holder; it is possible to simplify an assembly procedure; and it is possible to improve assembly efficiency while reducing an assembly failure when handling very small sized components.

In this embodiment, the reflection part 215 includes reflective surfaces 215a, 215b which are integrally formed with the internal body 216 corresponding to the conventional holder. The reflective surfaces 215a, 215b are provided on surfaces of the internal body 216.

The internal body 216 may be manufactured to a predetermined shape by a mold. For example, the internal body 216 may be formed by injection molding. Further, the internal body 216 has a pair of inclined bases for forming reflective surfaces 215a, 215b. When the reflective surfaces 215a, 215b are formed on an inclined surface of the base, the internal body 216 and the reflector 215 may be formed as an integral body.

The internal body 216 may be formed of various materials, such as plastics. The reflective surfaces 215a, 215b may be integrally formed with the surfaces of the internal body 216 by coating a reflective material or reflective member on the surfaces of the internal body 216 for forming the reflective surfaces 215a, 215b.

The internal body 216 may be formed of an opaque plastic material, capable of blocking light, by injection molding. If the internal body 216 is formed of a transparent material, a light blocking material may be coated on a surface of the internal body 216.

The reflective material may include any metallic or non-metallic material, such as aluminum, silver, or the like, which has a high reflection coefficient. Alternatively, the reflective surfaces 215a, 215b may be formed by attaching reflective films on the surfaces of the internal body 216.

The reflection part 215 can provide a sufficient depth of focus through change of the optical path. In this embodiment, the reflection part 215 includes a first reflective surface 215a and a second reflective surface 215b. More specifically, the internal body 216 includes a pair of the bases which have tapered surface, and the reflective surfaces 215a, 215b are integrally formed with the surfaces of the pair of bases, respectively.

As a result, the reflection part 215 includes the pair of reflective surfaces 215a, 215b which are disposed parallel to each other. The pair of reflective surfaces 215a, 215b is provided to the surfaces of the pair of bases to be disposed at the same angle and parallel to each other.

In this embodiment, the pair of bases forms a pair of surfaces inclined at the same angle, and the reflective surfaces 215a, 215b having the same thickness are formed on the pair of bases, respectively. Thus, the pair of reflective surfaces 215a, 215b parallel to each other is formed integrally with the internal body 216. In other words, the pair of reflective surfaces 215a, 215b includes a first reflective surface 215a and a second reflective surface 215b, which is located downstream of the first reflective surface 215a.

The first reflective surface 215a reflects light in a direction substantially parallel to a surface of the optical sensor 212, and the second reflective surface 215b reflects light in a direction perpendicular to the surface of the optical sensor 212.

In this embodiment, the first reflective surface 215a reflects light perpendicular to the surface of the optical sensor 212 in the direction substantially parallel to the surface of the optical sensor 212, and the second reflective surface 215b reflects light substantially parallel to the surface of the optical sensor 212 in the direction substantially perpendicular to the surface of the optical sensor 212.

The first and second reflective surfaces 215a, 215b are inclined at an angle of 45 degrees with respect to the surface of the optical sensor 212, and light reflected by the second reflective surface 215b is incident on the optical sensor 212. The optical unit 210 may further include at least one optical member provided to the internal body 216. More specifically, the optical unit 210 may further include a lens 217. The lens 217 is a convex lens and concentrates light traveling along the optical path.

The lens 217 mounted on the internal body 200 is aligned in the optical path and is disposed between the pair of reflective surfaces 215a, 215b. As a result, light traveling along the optical path enters the optical sensor 212 via the first reflective surface 215a, the lens 217, and the second reflective surface 215b.

The internal body 216 is formed with a lens mounting recess in which the lens 217 is installed. The lens 217 includes a lens body to concentrate light and a lens support integrally formed with the lens body and inserted into the mounting recess. The internal body 216 is disposed in the housing 214, which has an interface surface for manipulating the optical pointing device.

The housing 214 has a cap shape opened at a bottom thereof The housing 214 has a hollow body, into which the internal body 216 is inserted. The housing 214 may have a flat or curved top surface and at least a part of the top surface of the housing 214 serves as the interface surface.

The interface surface of the housing 214 is illuminated by the light source 211, which is disposed in the internal body 216. The light source 211 is mounted on a light source accommodating part in the internal body 216 and is electrically connected to the printed circuit board 213 having the optical sensor 212 mounted thereon. The light source 211 may be connected to the printed circuit board 213 via an FPCB. Alternatively, the light source 211 may be directly mounted on the printed circuit board 213.

Further, the internal body 216 is disposed above the printed circuit board 213. In this embodiment, the printed circuit board 213 is coupled to the bottom of the housing 214 to form the bottom of the pointing unit, i.e. the interface unit 210.

On the other hand, the light source 211 may be an IR source which emits infrared light. More specifically, the light source 211 may include an IR LED module which emits infrared light. Since the IR source emits infrared light, it does not cause fatigue to the eyes of a user, compared to a visible light source of high brightness, even when the eyes of the user are exposed to the infrared light for a long period of time.

Further, the housing 214, particularly, the interface surface, may transmit light only in the infrared wavelength band. For this, the top cover of the housing 214 may include an IR band pass filter that transmits light only in the infrared wavelength band.

More specifically, to allow top cover of the housing 214 to include the IR band pass filter, top cover of the housing 214 may be formed of an optical glass or optical plastic that can transmit light only in the infrared wavelength band. Alternatively, the IR band pass film may be attached to a transparent glass or plastic or an IR band pass material may be coated thereon.

Further, a light blocking film or tape may be attached to the rest of top cover of the housing 214, excluding the region corresponding to the interface surface, to block light. Alternatively, a light blocking material may be coated thereon to block light.

The rim of the housing 214 may also be formed of the light blocking material. The top cover and the rim of the housing 214 may be integrally formed by injection molding or may be formed by co-injection molding. Alternatively, the top cover and the rim may be individually formed and coupled to each other.

According to the input device 200, particularly, the pointing unit 210, having the configuration described above, infrared light emitted from the light source 211 passes through the housing 214, reflects from an object (e.g., a finger) and returns to the inside of the housing 214.

At this time, since sunlight or light emitted from external lighting and having a predetermined wavelength band, e.g., ultraviolet light or visible light, is blocked by an upper cover of the housing 214, the input device may prevent or minimize spill light from reaching the optical sensor 212, thereby enhancing manipulation precision based on movement of an object.

Further, infrared light reflected by the object and entering the housing 214 is reflected by the first reflective surface 215a in a direction parallel to a surface of the optical sensor 212 and focused while passing through a lens 217.

Then, the infrared passing through the lens 217 is reflected by the second reflective surface 215b in a direction perpendicular to the optical sensor 212 and reaches the optical sensor 212.

Meanwhile, the pointing unit 210 may further include a light shielding member 218 disposed on a path of light and formed with a light hole. The light shielding member 218 is disposed on the path of light and reduces a cross-section of a light passage in order to allow only a portion of light directed toward the optical sensor 212 to pass therethrough, thereby improving precision of the pointing unit 210.

In more detail, when light travels along an optical path, only the light passing through the light hole can arrive at the optical sensor 212 and the other light is blocked by the light shielding member 218.

The light shielding member 218 may be manufactured separately from the internal body 216 and then coupled to the internal body 216. Alternatively, the light shielding member 218 may be integrally formed with the internal body 216.

In this embodiment, the light shielding member 218 is illustrated as being manufactured separately from the internal body 216 to be mounted on the internal body 216. The internal body 216 has an insertion hole, to which the light shielding member 218 is mounted.

The light shielding member 218 may be disposed between the pair of reflective surfaces, but is not limited thereto. Further, in the case where the lens 217 is disposed in the housing 214, the light shielding member 218 is disposed at one side of the lens 217, preferably downstream of the lens 217.

The light shielding member 218 blocks spill light, which spreads outward due to diffusive reflection, scattering or diffusion and causes deterioration in recognition rate of the optical sensor 212, thereby improving manipulation precision of the optical pointing device.

Examples of the light shielding member 218 include a film made of a light-shielding plastic material, i.e. a light-shielding film. Alternatively, the light shielding member 218 may be made of a metallic or non-metallic material. The center of the light hole is coincident with the central line of light traveling along the optical path. More specifically, the center of the light hole is coincident with the central axis of the lens 217. The light hole may have a predetermined size depending on design requirements.

Therefore, light in a predetermined region around the central line of light traveling along the optical path passes through the light hole, but other light is blocked by the light shielding member 218.

Since the optical guide may include a component such as an optical fiber in addition to the components described above, not only the pointing unit described as the interface unit in this embodiment but also pointing units of other structures may be applied to the invention.

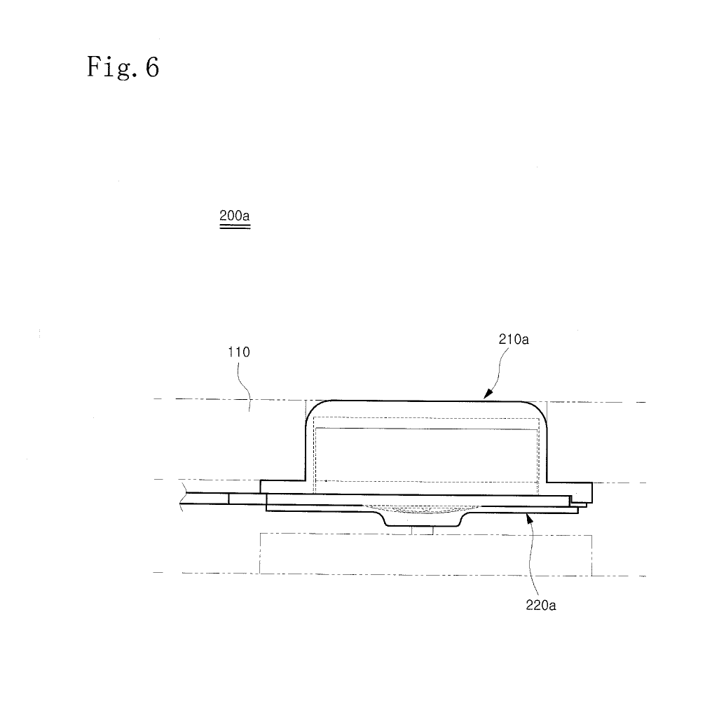

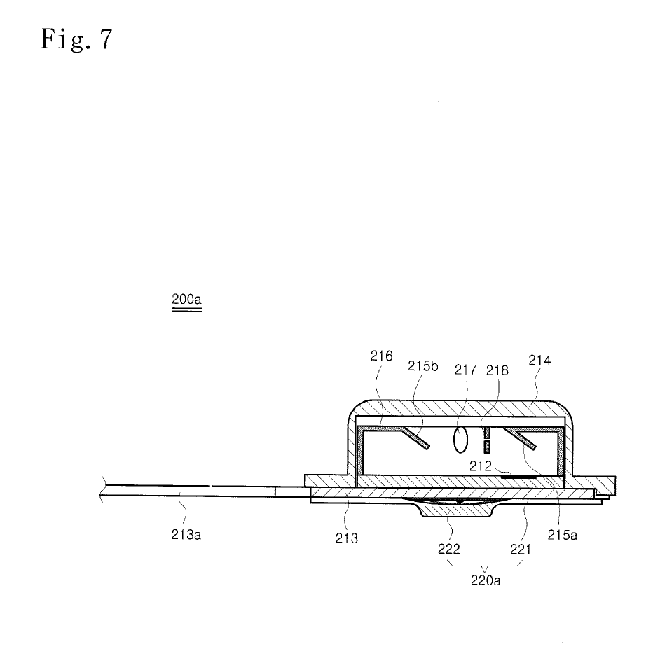

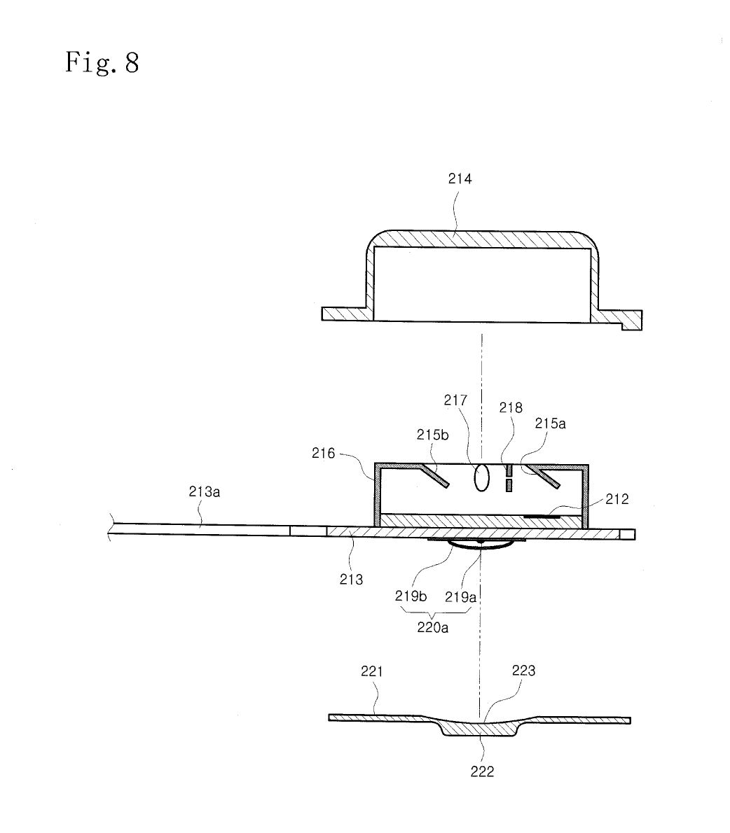

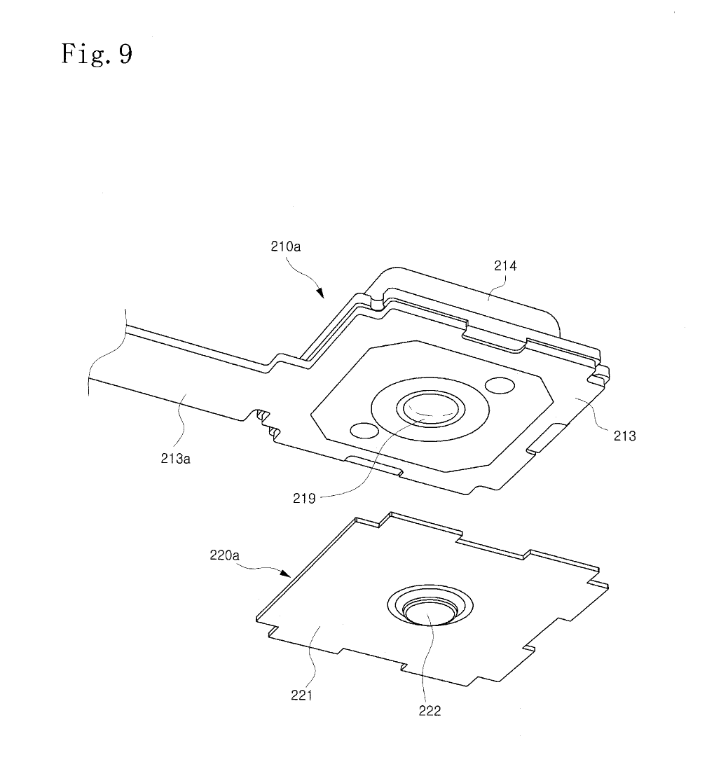

Next, an input device according to a second exemplary embodiment will be described with reference to FIGS. 6 to 9.

A light pointing device 200a according to the second exemplary embodiment includes an interface unit 210a, and a bottom pad 220a stacked on the bottom of the interface unit 210a. Further, the interface unit 210a includes an interface body, a circuit board 213 disposed in the interface body, and a pressing switch 219.

The pressing switch 219 is disposed between the circuit board 213 and the bottom pad 220a, and compressed by the bottom pad 220a when a user presses the interface unit 210a.

Specifically, when a user presses the interface unit 210a, the interface unit 210a is moved downwards. As the interface unit 210a is moved downwards, the pressing switch 219 is compressed by the bottom pad 220a. At this time, the bottom pad 220a is supported by the bottom of the mounting part disposed in the main body 110 of the electronic device in order to mount the input device 200 thereto.

In this embodiment, the pressing switch 219 is disposed on the bottom of the circuit board 213 and protrudes downward from the bottom of the circuit board 213. In this embodiment, a dome switch is disclosed as an example of the pressing switch 219, and includes a contact point 219a on the circuit board 213 and a dome 219b covering the contact point 219b.

The bottom pad 220a has a top surface with a switch groove on which the pressing switch 219 is located. In this embodiment, the bottom pad 220a includes a base pad part 221 contacting the circuit board 213, and a press pad part 222 stacked under the pressing switch 219 to selectively compress the pressing switch 219.

The press pad part 222 has the top surface which contacts the pressing switch 219. Further, the press pad part 222 is formed at the top surface thereof with a recess 223, i.e. the switch groove for accommodating the pressing switch 219. The recess 223 has a shape corresponding to the pressing switch 219 and the press pad part 222 protrudes downwards from the base pad part 221.

Thus, if the input device 200a is pressed downwards, the press pad part 222 is compressed upwards by the main body 110 of the electronic device and the base pad part 221 is compressed downwards by the circuit board 213, so that the bottom pad 220a is elastically deformed.

In this embodiment, the base pad part 221 is integrally formed with the press pad part 222. Advantageously, the bottom pad 220a is secured to the bottom of the circuit board 213 and modularized together with the interface unit 210 as in the first exemplary embodiment, such that the input device 200a can be easily assembled to the main body 110 of the electronic device.

Fixing between the bottom pad 220a and the interface unit 210a may be achieved using the same method as in the above embodiment, for example, an attaching method.

The bottom pad 220a is manufactured to have a thickness corresponding to design requirements of the electronic device 100. In the case where the base pad part 221 is integrally formed with the press pad part 222, at least one of the base pad part 221 and the press pad part 222 is attached to the bottom of the interface unit 210a.

The bottom pad 220a may include a pad layer having any one of a soft material, a cushioning material and an elastic material such that a user can smoothly manipulate the input device 200a. In more detail, the pad layer may be one of a silicon pad, a urethane pad and a rubber pad. The bottom pad 220a may have an alignment mark for aligning with the pressing switch 219.

Further, the input device 200a may include at least one of a pointing unit, a sensing unit, a fingerprint recognition unit, and a click unit, which has the circuit board 213 and the pressing switch 219, as an example of the interface unit 210a. The purpose of the bottom pad 200a is the same as in the above embodiment.

In this embodiment, components of the pointing unit 210a other than the pressing switch 219 are the same as those of the above embodiment. Further, like components are denoted by like reference numerals and repeated descriptions thereof will be omitted herein.

The bottom pad 220a may further include a protrusion on the bottom of the press pad part 222 as in an input device according to a third exemplary embodiment.

Operation of the optical pointing device according to this embodiment will hereinafter be described.

Infrared light emitted from the light source 211 passes through the housing 214, particularly, the interface surface of the top cover, is reflected by an object (finger), and is finally introduced into the housing 214.

Here, since light, for example, ultraviolet light or visible light, in a predetermined wavelength band emitted from an external light source or the sun is blocked by the housing 214, exterior noisy light can be minimized or prevented from reaching the optical sensor 212, thereby enhancing manipulation accuracy in response to movement of the object.

After being reflected into the housing 214, the IR light is reflected in the direction parallel to the surface of the optical sensor 212 by the first reflective surface 215a and is concentrated through the lens 320.

Infrared light passing through the lens 217 reaches the second reflective surface 215b via the light hole of the light shielding member 218. At this time, infrared light outside a predetermined region around the central line of the infrared light, i.e., infrared light outside the diameter of the light hole, is blocked by the light shielding member 218. Further, infrared light reaching the second reflective surface 215b is reflected by the second reflective surface 215b in a direction substantially perpendicular to the optical sensor 212, and reaches the optical sensor 212.

When a user presses the input device 200a to input data or signals or to handle the electronic device such that the pressing switch 219 is compressed by the bottom pad 220a, a predetermined signal is generated and transmitted to the main circuit board of the electronic device 100 via the connector 213a.

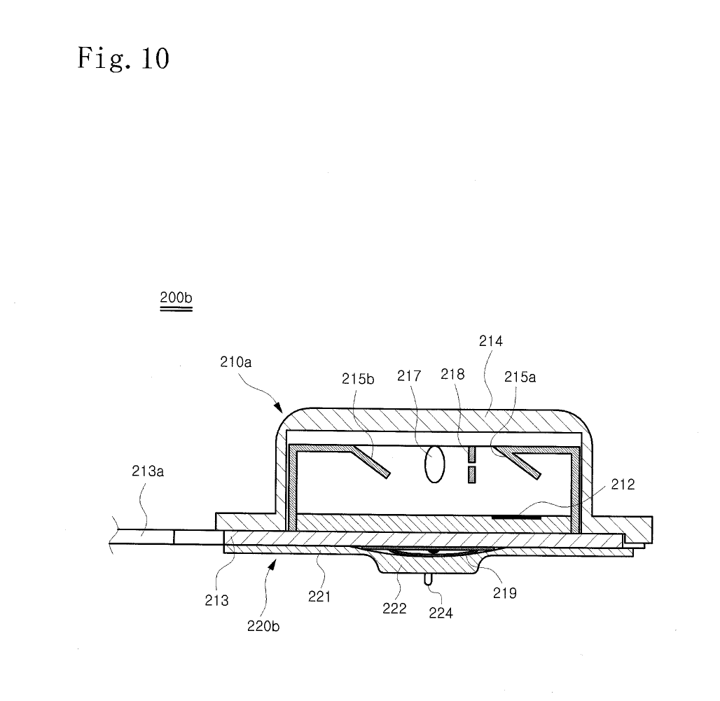

Referring to FIG. 10, the input device 200b according to the third exemplary embodiment includes an interface unit 210a and a bottom pad 220b disposed on the bottom of the interface unit 210a as in the second exemplary embodiment. Further, a protrusion 224 protrudes downwards from the bottom of the bottom pad 220b.

The bottom pad 220a includes a base pad part 221 and a press pad part 222 as in the above embodiment, and the protrusion 224 is disposed on the bottom of the press pad part 222.

In this embodiment, components of the input device other than the projection 224 are the same as those in the above second exemplary embodiment. Further, like components are denoted by like reference numerals and repeated descriptions thereof will be omitted herein.

The input device according to the exemplary embodiments and the electronic device including the same have the following advantageous effects.

First, the input unit, for example, an interface unit such as a pointing unit, can be used irrespective of variation in the design of an electronic device.

Second, compatibility of the interface unit may lead to a reduction in manufacturing costs of the input device, and the input device may cope with design change of an electronic device since the thickness of the input device can be supplemented through simple operation of stacking a bottom pad corresponding to a changed size, i.e. a changed thickness of the electronic device, on the bottom of the interface unit.

Third, the input device ensures smooth manipulation of the input device by a user, and the input device having a bottom pad is modularized and assembled to a main body of the electronic device, thereby improving assembly efficiency and productivity.

Although some embodiments have been described herein, it will be apparent to those skilled in the art that these embodiments are given by way of illustration, and that various modifications, changes, and variations can be made without departing from the spirit and scope of the invention. Accordingly, the scope of the invention should be limited only by the accompanying claims and equivalents thereof.

What is claimed is:

1. An input device of an electronic device, comprising:
an interface unit mounted on a main body of an electronic device; and
a bottom pad having a predetermined thickness and stacked on a bottom of the interface unit.

2. The input device of claim 1, wherein the bottom pad comprises a pad layer comprising one of a soft material, a cushioning material and an elastic material.

3. The input device of claim 2, wherein the pad layer comprises one of a silicon pad, a urethane pad and a rubber pad.

4. The input device of claim 1, wherein the bottom pad is disposed in the interface unit to adjust a thickness of the input device in accordance with variation in size of the electronic device.

5. The input device of claim 4, wherein the interface unit comprises an interface body for an interface, and a circuit board in the interface body.

6. The input device of claim 5, wherein the interface unit further comprises a pressing switch disposed between the circuit board and the bottom pad and compressed by the bottom pad as the interface unit is pressed down.

7. The input device of claim 6, wherein the pressing switch protrudes downwards from a bottom of the circuit board, and
wherein the bottom pad comprises a base pad part contacting the circuit board, and a press pad part disposed on the base pad part and protruding downwards from the base pad part to compress the pressing switch.

8. The input device of claim 7, wherein the press pad part comprises a top surface contacting the pressing switch, the top surface of the press pad part comprising a recess for accommodating the pressing switch.

9. The input device of claim 7, further comprising a protrusion on a bottom of the press pad part.

10. The input device of claim 7, wherein the base pad part is integrally formed with the press pad part.

11. The input device of claim 6, wherein the bottom pad comprises an alignment mark for aligning with the pressing switch.

12. The input device of claim 1, wherein the bottom pad is attached to the bottom of the interface unit.

13. The input device of claim 1, wherein the interface unit comprises at least one of a pointing unit, a sensing unit, a fingerprint recognition unit, and a click unit.

14. The input device of claim 13, wherein the pointing unit comprises a signal source generating a pointing signal, a sensor sensing the signal, a circuit board electrically connected to the sensor, and a housing defining an outer appearance of the pointing unit.

15. An input device of an electronic device, comprising:
a pointing unit mounted on a main body of the electronic device, the pointing unit comprising a light source for emitting pointing light, an optical sensor for sensing light, a circuit board electrically connected to the optical sensor, and a housing defining an outer appearance of the pointing unit; and
a bottom pad having a predetermined thickness and stacked on a bottom of the pointing unit, the bottom pad comprising a pad layer which comprises one of a soft material, a cushioning material and an elastic material.

16. The input device of claim 15, wherein the pointing unit further comprises a pressing switch disposed between the circuit board and the bottom pad and compressed by the bottom pad as the pointing unit is pressed down.

17. The input device of claim 16, wherein the pressing switch protrudes downwards from a bottom of the circuit board,
wherein the bottom pad comprises a base pad part contacting the circuit board, and a press pad part disposed on the base pad part and protruding downwards from the base pad part to compress the pressing switch, and
wherein the press pad part comprises a top surface contacting the pressing switch, the top surface of the press pad part comprising a recess for accommodating the pressing switch.

18. The input device of claim 16, wherein the pressing switch comprises a dome switch.

19. The input device of claim 1, wherein the bottom pad is attached to the bottom of the circuit board.

20. An electronic device, comprising:
a main body of the electronic device having a main circuit board;
an interface unit mounted on the main body of the electronic device; and
a bottom pad having a predetermined thickness and stacked on a bottom of the interface unit.
